(19) United States
(12) Patent Application Publication
(10) Pub. No.: US 2015/0270746 A1
(43) Pub. Date: Sep. 24, 2015

(54) MOTOR AND MANUFACTURING METHOD THEREOF

(71) Applicant: Mitsubishi Electric Corporation, Tokyo (JP)

(72) Inventor: Shinji Nishimura, Tokyo (JP)

(73) Assignee: Mitsubishi Electric Corporation, Tokyo (JP)

(21) Appl. No.: 14/427,848

(22) PCT Filed: Mar. 22, 2013
(86) PCT No.: PCT/JP2013/058271

§ 371 Date: Mar. 12, 2015

(51) Int. Cl. H02K 1/14; H02K 15/06; H02K 3/28

(52) U.S. Cl. CPC H02K 1/146; H02K 3/28; H02K 15/066

(57) ABSTRACT

A motor of the present invention is configured in such a way that a side surface of a teeth portion and a side surface, which is faced to the side surface, of a neighboring teeth portion, in which an inner circumference side tip of the teeth portion is excepted, are positioned in parallel at a slot in which a coil of a stator, which is configured in a cylinder shape, is installed, and self-both side surfaces at the inner circumference side tip of the teeth portion are positioned in parallel. Thereby, a high electric power of the motor can be generated, and the coil can be installed to a tip of the teeth portion.

### TECHNICAL FIELD

The present invention relates to a motor and a manufacturing method of the motor, and particularly relates to a motor in which a high electric power is generated, and a coil can be inserted to a tip of a teeth portion.

### BACKGROUND ART

In a conventional motor in this family, for example, there is a known motor which is disclosed in Patent Document 1. Patent Document 1 discloses a stator of a motor which includes a separation-type armature core, in which a teeth portion is included at an inner circumference side, a coil which is inserted to the teeth portion of the separation-type armature core, and an insulator which is arranged between the separation-type armature core and the coil at the teeth portion. Both sides of the teeth portion are formed in parallel at a basic portion of the teeth portion, and an inner circumference side tip of the teeth portion is formed in a trapezoidal shape in a state where the tip is tapered.

FIG. 4 is a cross-sectional view illustrating a conventional separation-type armature core having a flange. The teeth portion 2 having a flange is included in the separation-type armature core 4, and the coil 3 is wound around the teeth portion 2.

### CONVENTIONAL ART DOCUMENT

### Patent Document

Patent Document 1: Japanese Laid-Open Patent Publication No. 2010-136486 (FIG. 3)

### SUMMARY OF THE INVENTION

### Problems to be solved by the Invention

When an inner circumference side tip of a teeth portion is formed in a trapezoidal shape in a state where the tip is tapered, facing side surfaces of a slot, in which a coil is installed, can be formed in parallel. However, a surface area of the teeth portion is decreased at an inner circumference side of an armature core, in other words, an air gap area is decreased. Therefore, when a magnetic flange is provided at the inner circumference side tip of the teeth portion (refer to FIG. 4), the air gap area is increased. However, there is a problem in that the coil is hooked to the magnetic flange when the coil is inserted, so that the coil cannot be directly inserted to the teeth portion.

In order to solve the above-described problem, the present invention supplies a motor and a manufacturing method of the motor in which a teeth portion is formed in a special shape, and a high electric power is generated, and a coil can be inserted from a tip of the teeth portion.

### Means for Solving Problems

A motor of the present invention includes a stator in which a plurality of separation-type armature cores, in which a coil is intensively wound at a teeth portion, are arranged so as to be configured in a cylinder shape; and a rotor which is rotatably supported at an inner circumference side of the stator via an air gap; wherein a side surface of the teeth portion and a side surface, which is faced to the side surface, of the neighboring teeth portion, in which an inner circumference side tip of the teeth portion is excepted, are positioned in parallel at a slot in which the coil of the stator, which is configured in a cylinder shape, is installed, and self-both side surfaces at the inner circumference side tip of the teeth portion are positioned in parallel.

Moreover, in a manufacturing method of the motor of the present invention, the coil, which is previously configured, is inserted to the teeth portion and the plurality of separation-type armature cores, in which the coil is inserted to the teeth portion, are arranged so as to be configured in a cylinder shape, and the plurality of separation-type armature cores, which are configured in a cylinder shape, are burn-fitted or press-fitted to a cylinder ring.

### EFFECTS OF THE INVENTION

According to a motor and a manufacturing method of the motor of the present invention, a side surface of the teeth portion and a side surface, which is faced to the side surface, of the neighboring teeth portion, in which an inner circumference side tip of the teeth portion is excepted, are positioned in parallel at a slot in which the coil of the stator, which is configured in a cylinder shape, is installed, and self-both side surfaces at the inner circumference side tip of the teeth portion are positioned in parallel, whereby an surface area of the teeth portion at the inner circumference side of the separation-type armature cores is increased, and an area of the air gap can be increased, so that a motor, in which a high electric power is generated, can be obtained, and moreover, the coil can be easily inserted from the tip of the teeth portion to the slot between the teeth portions.

An aim, a characteristic, a viewpoint, and an effect of the present invention, which are not described in the above explanations, will be cleared by the following detail explanations for the present invention in reference to drawings.

### BRIEF DESCRIPTION OF THE DRAWINGS

FIG. 1 is a cross-sectional view illustrating a configuration of a motor according to Embodiment 1 of the present invention;

FIG. 2 is an enlarged cross-sectional view illustrating a separation-type armature core according to Embodiment 1 of the present invention;

FIG. 3 is a disassembled cross-sectional view, at a time of assembling the separation-type armature core, for explaining a manufacturing method of the separation-type armature core according to Embodiment 1 of the present invention; and

FIG. 4 is a cross-sectional view illustrating a conventional separation-type armature core having a flange.

### MODE FOR CARRYING OUT THE INVENTION

### Embodiment 1

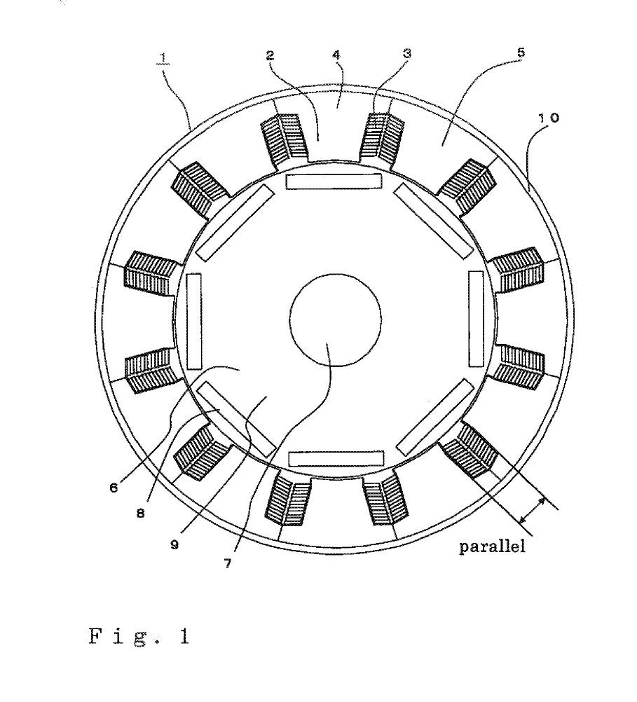

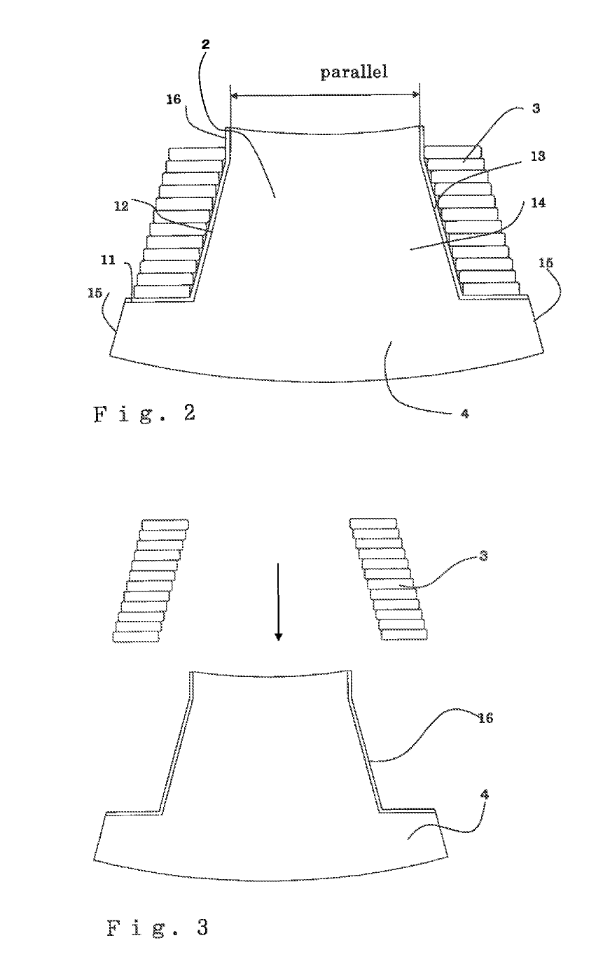

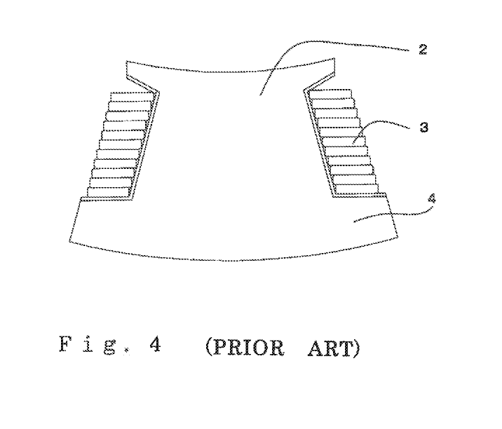

Hereinafter, a motor according to Embodiment 1 of the present invention will be explained in reference to FIG. 1 through FIG. 3. FIG. 1 is a cross-sectional view illustrating a configuration of the motor according to Embodiment 1 of the present invention, and the cross-sectional view is vertical with respect to a rotary shaft of the motor. FIG. 2 is an enlarged cross-sectional view illustrating a separation-type armature core according to Embodiment 1 of the present invention. FIG. 3 is a disassembled cross-sectional view, at a time of assembling the separation-type armature core, for explaining a manufacturing method of the separation-type armature core according to Embodiment 1 of the present invention.

In FIG. 1, a motor 1 includes a stator 5 in which a plurality of separation-type armature cores 4, in which a coil 3 is intensively wound at a teeth portion 2, are arranged so as to be configured in a cylinder shape, and a rotor 6 which is rotatably supported at an inner circumference side of the stator 5 via an air gap. The rotor 6 includes a rotary shaft 7 which is supported by a bearing (not illustrated), and a magnetic component 9, in which a permanent magnet 8 is inserted, is fixed to the rotary shaft 7. For example, twelve separation-type armature cores 4 are arranged in a cylinder shape at the stator 5, and the coil 3 is inserted to the teeth portion 2 so as to be supported at each of the separation-type armature cores 4. The stator 5, which is configured in a cylinder shape, is burn-fitted or press-fitted to a cylinder ring 10 so as to be tightly fixed.

In FIG. 2, the separation-type armature core 4 is formed in such a way that electromagnetic steel sheets, which are pressed and formed, are laminated, and the separation-type armature core 4 includes the teeth portion 2 and a slot surface 11. A basic portion 14, which is composed of self-both side surfaces 12 and 13 of the teeth portion 2, is formed in a trapezoidal shape in a state where a tip side is tapered, and both side surfaces 12 and 13 at an inner circumference side tip, which is extended from the basic portion 14, are formed in parallel. The separation surfaces 15 are formed at the separation-type armature cores 4, and when the separation-type armature cores 4 are arranged in a cylinder shape, the separation surfaces 15 of the neighboring separation-type armature cores 4 are contacted each other.

The coil 3 is wound and configured in such a way that a rectangular conductor is edgewise bent. The rectangular conductor is edgewise bent, whereby an area ratio of the coil 3 (a ratio of a coil area to a slot area) can be increased. An insulating coat, such as an enamel coat, is coated on a surface of the coil 3. The coil 3 is connected to a bus bar which is not illustrated. The coil 3 is wound in accordance with an outside shape of the trapezoidal shape of the basic portion 14 of the teeth portion 2 of the separation-type armature core 4, so that the coil 3 is wound so as to be extended toward the basic portion 14 side of the teeth portion 2. It is desirable that a cross-sectional area of the rectangular conductor, which is used for the coil 3, is identical between a leading portion and a terminating portion of the coil 3. An insulating paper 16, which has a heat-resistant capability and a high insulation capability, is provided between the coil 3 and the separation-type armature core 4 in order to insulate the coil 3 and the separation-type armature core 4.

When the motor 1 is assembled in reference to FIG. 3, the coil 3, which is wound and previously configured in such a way that the rectangular conductor is edgewise bent, is inserted to teeth portion 2, on which the insulating paper 16 is provided, from the tip at the inner circumference side in an arrow direction. The separation-type armature core 4 is illustrated in FIG. 2 in a state where the coil 3 is inserted. The surface of the coil 3 is processed by a resin mold. In a next process, a plurality of separation-type armature cores 4 are arranged in a cylinder shape in such a way that the separation surfaces 15 are faced to each other. The metallic cylinder ring 10, of which inner diameter is slightly shorter than an outer diameter of the plurality of separation-type armature cores 4 which are arranged in a cylinder shape, is prepared, and the heated metallic cylinder ring 10 is fitted to the cylindrical separation-type armature cores 4, and the cylinder ring 10 is cooled and tightened, whereby the cylindrical separation-type armature cores 4 can be tightly supported by the cylinder ring 10. As described above, the stator 5, which is fired by the cylinder ring 10, is assembled.

In Embodiment 1, a side surface 13 of the teeth portion 2 and a side surface 12, which is faced to the side surface 13, of the neighboring teeth portion 2, in which an inner circumference side tip of the teeth portion 2 is excepted, are positioned in parallel at a slot in which the coil 3 of the stator 5, which is configured in a cylinder shape, is installed. Moreover, self-both side surfaces 12 and 13 at the inner circumference side tip of the teeth portion 2 are positioned in parallel, and the basic portion 14, which is formed in a trapezoidal shape, of the teeth portion 2 reaches to the inner circumference side tip in FIG. 2, whereby an surface area of the teeth portion 2 at the inner circumference side of the separation-type armature cores 4 is increased, and an area of the air gap can be increased, so that a motor, in which a high electric power is generated, can be obtained. In other words, the both side surfaces 12 and 13 at the inner circumference side tip of the teeth portion 2 are positioned in parallel, so that the surface, which is faced to the rotor 6, can be widely configured, and an interlinkage magnetic flux of the coil 3 can be increased. Moreover, a flange is not provided at the inner circumference side tip of the teeth portion 2, so that the coil 3 can be easily inserted from the tip of the teeth portion 2 to the slot between the teeth portions 2.

In addition, in the scope of the present invention, it is possible that the embodiment is suitably modified or omitted.

What is claimed is:

1. A motor comprising:
a stator in which a plurality of separation-type armature cores, in which a coil is intensively wound at a teeth portion, are arranged so as to be configured in a cylinder shape; and
a rotor which is rotatably supported at an inner circumference side of the stator via an air gap; wherein
a side surface of the teeth portion and a side surface, which is faced to the side surface, of the neighboring teeth portion, in which an inner circumference side tip of the teeth portion is excepted, are positioned in parallel at a slot in which the coil of the stator, which is configured in a cylinder shape, is installed, and self-both side surfaces at the inner circumference side tip of the teeth portion are positioned in parallel.

2. A motor as recited in claim 1, wherein the coil, which is wound around the separation-type armature cores, is configured in such a way that a rectangular conductor is edgewise bent.

3. A manufacturing method of the motor as recited in claim 1, wherein the coil, which is previously configured, is inserted to the teeth portion, and the plurality of separation-type armature cores, in which the coil is inserted to the teeth portion, are arranged so as to be configured in a cylinder shape, and the plurality of separation-type armature cores, which are configured in a cylinder shape, are burn-fitted or press-fitted to a cylinder ring.
